(19) United States
(12) Patent Application Publication
(10) Pub. No.: US 2007/0068638 A1
(43) Pub. Date: Mar. 29, 2007

(54) Anti-wind buffeting device for an automobile

(76) Inventors: Mitchell M. Puskarz, Troy, MI (US); Robert J. Faubert, Rochester Hills, MI (US); Robert R. Lazarevich, Rochester, MI (US); Raja Hazime, Dearborn Heights, MI (US); Richard A. Manning, Sterling Heights, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/237,078

(22) Filed: Sep. 28, 2005

(51) Int. Cl. B60J 1/20

(52) U.S. Cl. 160/370.22

(57) ABSTRACT

A sun, privacy, and anti-wind buffeting shade assembly is provided for a window opening in an automotive vehicle. The shade assembly includes a flexible screen having a multiplicity of perforations. The screen is extended across the window opening to provide shade and privacy and to dampen wind buffeting inside the vehicle.

### FIELD OF THE INVENTION

The present invention relates generally to window shades for automotive vehicles and more particularly to a sun, privacy, and anti-wind buffeting shade.

### BACKGROUND OF THE INVENTION

Wind buffeting noise is caused by wind entering a moving motor vehicle through an open window and can result in pressure changes within the vehicle. It is desired to eliminate or at least substantially reduce or dampen wind buffeting when a vehicle window is open and the vehicle is traveling.

### SUMMARY OF THE INVENTION

In accordance with the present invention, a sun, privacy, and anti-wind buffeting shade assembly is provided for a window opening in an automotive vehicle. The shade assembly comprises a flexible screen having a multiplicity of perforations, and a holder for storing the screen. The screen is capable of being withdrawn from the holder to an extended position across the window opening. The screen provides shade and privacy and dampens wind buffeting resulting from air entering the vehicle through the window opening when the vehicle is traveling.

Further in accordance with the invention, the holder comprises a roller on which the screen is wound. The screen can be unwound from the roller to the extended position. Preferably a retainer is provided for retaining the screen in the extended position.

In accordance with the specific embodiment about to be described, the window opening is in a rear door of the vehicle and has a window which can be moved up and down to close and open the opening. One or more hooks on the window engage the screen so that when the window is opened, the screen is automatically unwound from the roller and drawn to an extended position closing the opening. Preferably the hook or hooks can be disengaged from the screen so that the screen can be drawn to the extended position independently of the window.

One object of this invention is to provide a sun, privacy, and anti-buffeting shade assembly having one or more of the foregoing features and capabilities.

Other objects, features, and advantages of the invention will become more apparent as this description proceeds.

Further areas of applicability of the present invention will become apparent from the detailed description provided hereinafter. It should be understood that the detailed description and specific examples, while indicating preferred embodiments of the invention, are intended for purposes of illustration only and are not intended to limit the scope of the invention.

### BRIEF DESCRIPTION OF THE DRAWINGS

The present invention will become more fully understood from the detailed description and accompanying drawings, wherein:

FIG. 1 is a fragmentary side elevational view of the rear end portion of a motor vehicle showing a shade covering a rear door window, in accordance with this invention;

FIG. 2 is a fragmentary sectional view with parts broken away taken on the line 2-2 in FIG. 1;

FIG. 3 is a fragmentary perspective view on an enlarged scale showing the shade covering the window opening and omitting the door frame at the top to better illustrate the roller for the screen;

FIG. 4 is a view similar to FIG. 3 but shows the shade in its retracted position;

FIG. 5 is a fragmentary detail of a portion of FIG. 4; and

FIG. 6 is a view similar to FIG. 4, but shows a modification.

### DETAILED DESCRIPTION OF THE PREFERRED EMBODIMENTS

The following description of the preferred embodiments is merely exemplary in nature and is in no way intended to limit the invention, its application, or uses.

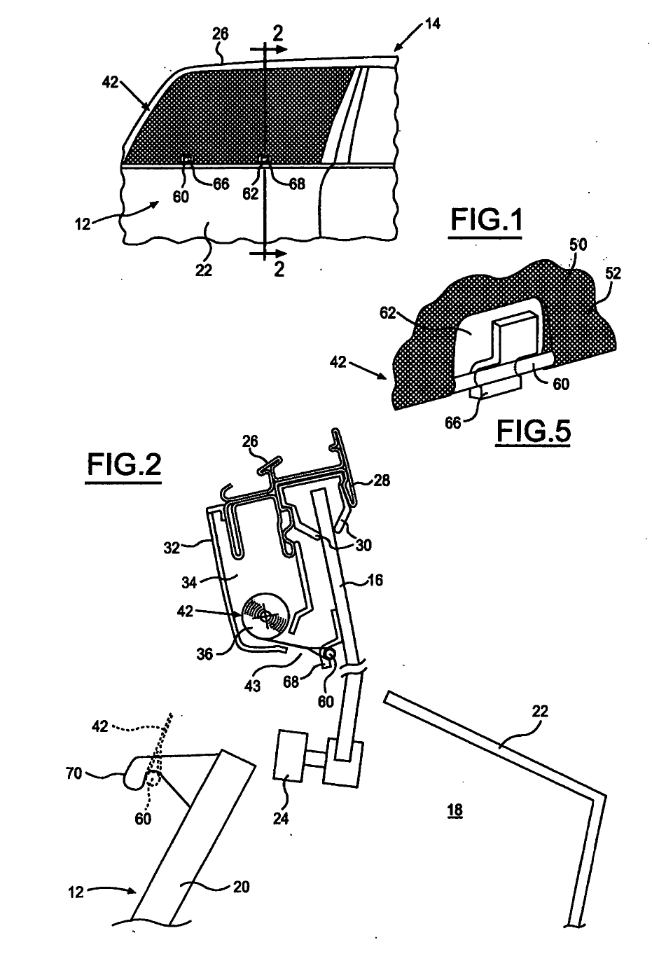

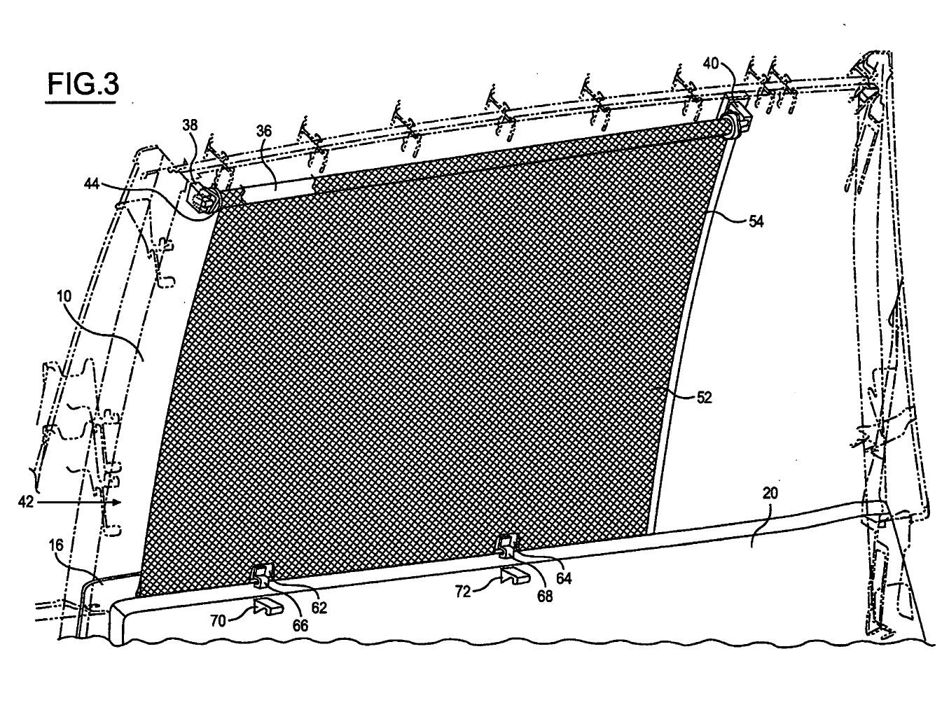

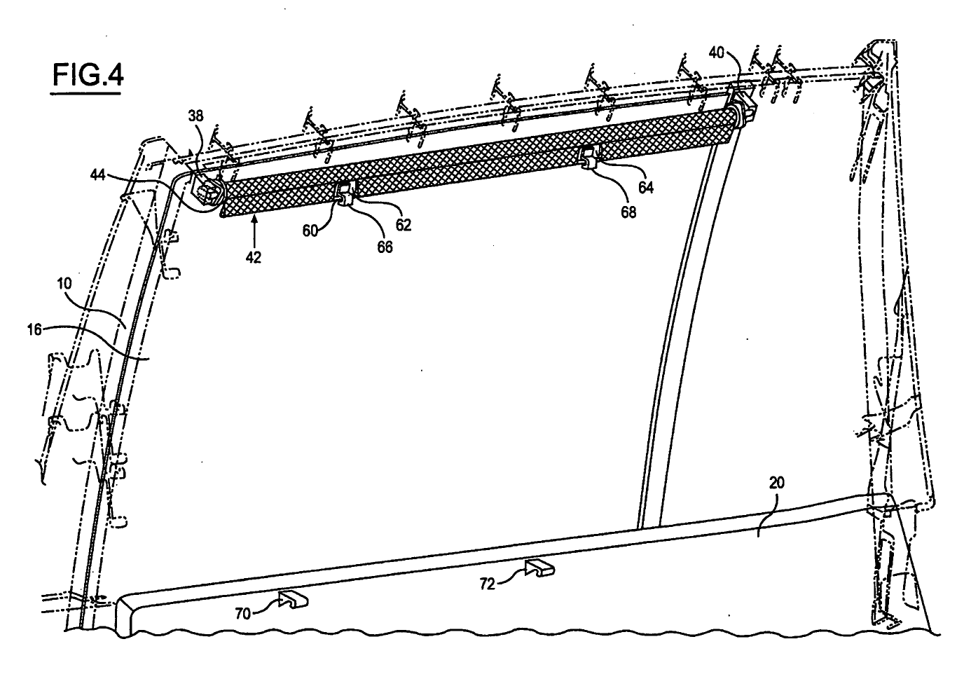

Referring now more particularly to the drawings and especially FIGS. 1-5, there is shown a window opening 10 in a rear door 12 on body of a motor vehicle 14. A clear glass window 16 is moved up to close the opening 10 and down into a window well 18 between inner and outer door panels 20 and 22 to open the opening. The window 16 may be manually operated or, as shown in FIG. 2, may be operated by a power unit 24 of conventional design.

Across the top of the door 12 is an elongated door frame 26 which extends along the upper edge of the opening 10. The door frame 26 has an elongated window frame 28 of generally inverted U-shape which receives the upper edge of the window 16 when the window is closed. The window frame has weather seals 30 in contact with the window 16 when the window is in the up or closed position.

The door frame 26 also has an elongated roller frame 32 of generally inverted U-shape on the inner side of the window frame 28, that is on the side of the window frame nearer to the inside of the vehicle. The roller frame 32 provides a housing 34 for a roller 36. The roller 36 is an elongated generally horizontal member extending lengthwise within the housing 34 and is rotatably supported on the ends by brackets 38 and 40 secured within the housing.

A sun, privacy, and anti-buffeting shade assembly comprises a screen 42 wound on the roller 36. The roller 36 serves as a holder for the screen 42. The screen can be unwound from the roller 36 and pulled downwardly through a slot 43 in the housing 34 to an extended position in which it fully, or substantially fully, covers the entire window opening 16. The roller 36 is of a type common in all private homes which has a spring 44 to axially rotate the roller in one direction to wind up the screen 42 on the roller. The roller can be axially rotated in the opposite direction against the force of the spring to unwind the screen from the roller by pulling the screen downwardly out of the housing 34 and across the window opening 16. When wound on the roller 36, the screen is fully concealed in the housing 34.

The screen 42 has a multiplicity of small perforations 50 therein. The screen is made of a flexible material which may, for example, be a suitable metal or plastic. Preferably the screen consists of a grid of crossing strands or wires 52 connected at the ends by a border strand or wire 54 around the periphery of the screen. As shown in FIG. 5, approximately half of the crossing strands of the grid are spaced apart and parallel to one another. The other half are perpendicular to those of the first half and spaced apart and parallel to one another to provide the perforations 50 in the screens. The perforations are preferably square and each perforation has a maximum cross-dimension preferably in a range of 0.5 to 1.0 millimeters, and most preferably 0.75 millimeters.

A rod 60 extends through a passage along the free edge of the screen 42. The free edge of the screen is cut away at two spaced points 62 and 64 to expose the rod. A screen puller comprises a pair of hooks 66 and 68 that are bonded or permanently secured to the window 16 in laterally spaced relation near its upper edge which engage over the rod 60 where the rod is exposed. Accordingly, when the window 16 is lowered to open the window opening, the hooks unwind the screen 42 from the roller 36 and draw the screen downwardly with the window to fully cover the window opening 10 when the window is in the open position. Likewise when the window 16 is moved up to its closed position, the screen 42 by operation of the spring 44 in the roller, is rewound on the roller and returns inside the housing and out of view.

The hooks 66 and 68 may be disengaged from the rod 60 if desired, so that the screen may be withdrawn from the housing and pulled down across the window opening 10, independently of the window 16. The inner panel 20 has a stationary retainer comprising a pair of hooks 70 and 72 which can be releasably engaged by the rod 60 where the rod is exposed to retain the screen in its extended position when the screen is operated independently of the window. The screen 42 may be drawn over the window opening 10 while the window 16 is closed to shield the passengers from the sun and also to provide a measure of privacy, but not, of course, to have any anti-wind buffeting effect.

When the window 16 is open and the screen 42 has been pulled down to its extended position by the open window, the screen provides not only protection from the sun, and privacy, but also eliminates or substantially eliminates or dampens the effects of wind buffeting resulting from wind entering the vehicle through the open window. Air can still enter the passenger compartment through the perforations 50.

As stated, the screen 42 can be operated independently of the window 16, but it is highly desirable to avail oneself of the automatic operation of the screen by having it close the window opening 10 whenever the window is opened. Then the full benefits of the screen are available. If it is desired to open the window without taking advantage of the screen 42, the screen may be unhooked from the window so that the window may be opened without lowering the screen.

The screen would not be associated with a front door window because it might interfere with the driver's operation of the vehicle. However, the screen may, if desired be associated with a sun roof window to eliminate wind buffeting when the sun roof is open and provide shade.

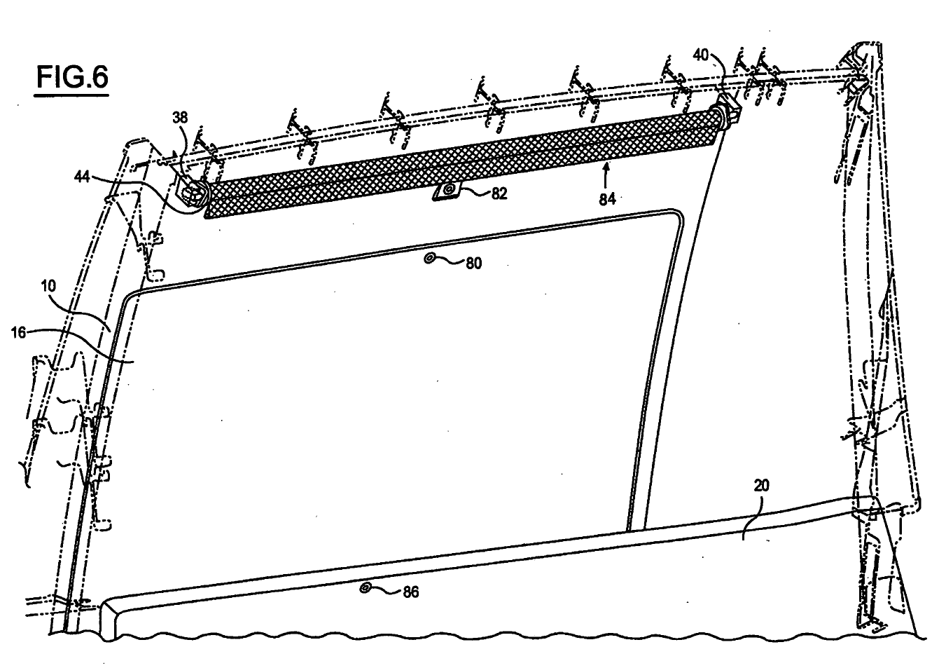

FIG. 6 shows a modification of the invention in which, instead of having the pair of hooks 66 and 68, the window 16 has a snap fastener 80 bonded or permanently secured to it near its upper edge and about midway of its width. The free edge of the screen has a complimentary snap fastener 82 which releasably engages the snap fastener 80 so that when the window 16 is lowered, the screen 84, similar to the screen 42, is also lowered to cover the window opening. A snap fastener 86 is secured to the inner panel 20 which is releasably engageable with the snap fastener 82 on the screen to hold the screen in its extended position when the screen is pulled down manually independently of the window.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A sun, privacy, and anti-wind buffeting shade assembly for a window opening in an automotive vehicle, comprising:
a flexible screen having a multiplicity of perforations, and
a holder on the vehicle for storing the screen,
said screen being capable of being withdrawn from the holder to an extended position across the window opening to substantially cover the window opening,
said screen providing shade and privacy and dampening wind buffeting inside the vehicle resulting from air entering the vehicle through the window opening when the vehicle is traveling.

2. The assembly of claim 1, wherein the holder comprises a roller on which the screen is wound, a roller frame adjacent one edge of the window opening providing a housing in which the roller is supported, said screen being capable of being unwound from the roller and withdrawn from the housing to the extended position.

3. The assembly of claim 2, further including a retainer for retaining the screen in the extended position.

4. The assembly of claim 3, wherein the screen has one end attached to the roller, and the retainer comprises a first fastener on a body portion of the vehicle engageable with a complimentary second fastener on an opposite end of the screen.

5. The assembly of claim 3, wherein the screen has one end attached to the roller, an elongated rod along an opposite end of the screen, and said retainer comprises a hook on a body portion of the vehicle engageable with the rod.

6. The assembly of claim 3, wherein each of said perforations has a maximum cross-dimension in a range of 0.5 to 1.0 millimeters.

7. The assembly of claim 2, wherein the window opening is in a rear door of the vehicle, and further including a window for the window opening, an actuator for moving the window with respect to the opening from a closed position to an open position, and
a screen puller on the window operable to unwind the screen from the roller and draw the screen to the extended position when the window is moved to the open position.

8. The assembly of claim 7, wherein the screen has one end attached to the roller, an elongated rod along an opposite end of the screen, and the screen puller comprises a hook on the window engageable with said rod.

9. The assembly of claim 8, wherein said screen puller includes a second hook on the window, said hooks being spaced from one another and engaging said rod at spaced points.

10. The assembly of claim 9, wherein said hooks are disengageable from said rod so that said screen can be drawn to the extended position independently of said window, and a retainer for retaining the said screen in the extended position.

11. The assembly of claim 10, wherein each of said perforations has a maximum cross-dimension in a range of 0.5 to 1.0 millimeters.

12. The assembly of claim 10, wherein said perforations are square and each has a maximum cross-dimension of 0.75 millimeters.

13. The assembly of claim 7, wherein said screen puller comprises a first fastener on said window releasably engageable with a complimentary second fastener on the screen.

14. The assembly of claim 13, further including a third fastener on the door releasably engageable with the second fastener on the screen to hold the screen in its extended position independently of the window.

15. The assembly of claim 14, wherein each of said perforations has a maximum cross-dimension in a range of 0.5 to 1.0 millimeters.

16. The assembly of claim 14, wherein said perforations are square and each has a maximum cross-dimension of 0.75 millimeters.
